(19) United States
(12) Patent Application Publication
(10) Pub. No.: US 2023/0111384 A1
(43) Pub. Date: Apr. 13, 2023

(54) SYSTEMS AND METHODS FOR ADVANCED VEHICLE REPAIR SYSTEMS

(71) Applicant: State Farm Mutual Automobile Insurance Company, Bloomington, IL (US)

(72) Inventors: Jaclyn P. Byers, Bloomington, IL (US); Julie L. Blankenship, Chandler, AZ (US); Dillon M. Carty, Cumming, GA (US); Patrick T. Carron, Oakwood, OH (US); Douglas A. Stevens, Atlanta, GA (US); Dustin Leland Barrons, Columbia, MO (US); Daphne Outerbridge Louie, Bloomington, IL (US)

(21) Appl. No.: 18/045,321

(22) Filed: Oct. 10, 2022

Related U.S. Application Data
(60) Provisional application No. 63/254,426, filed on Oct. 11, 2021.

(51) Int. Cl. G06Q 10/20; G06Q 10/0639; G06Q 10/0631

(52) U.S. Cl. CPC G06Q 10/20; G06Q 10/06393; G06Q 10/063114

(57) ABSTRACT

A system for monitoring a plurality of repair facilities configured to (i) store a plurality of historical vehicle repair information for a plurality of repair facilities; (ii) collect a plurality of vehicle repair information from the plurality of repair facilities; (iii) for each of the plurality of repair facilities, determine a current load for the corresponding repair facility; (iv) receive, from a user computer device 205, a query for information about one or more repair facilities; (v) generate a user interface to include results of the query based on the plurality of historical vehicle repair information and the plurality of vehicle repair information; and (vi) instruct the user computer device to display the user interface.

### CROSS-REFERENCE TO RELATED APPLICATIONS

This application claim priority to U.S. Provisional Patent Application No. 63/254,426, filed Oct. 11, 2021, entitled “SYSTEMS AND METHODS FOR ADVANCED VEHICLE REPAIR SYSTEMS,” the entire contents and disclosure of which are hereby incorporated herein by reference in its entirety.

### FIELD OF THE DISCLOSURE

The present disclosure relates to repairing damage to a vehicle and, more particularly, to a network-based system and method for real-time monitoring repairs being performed at a plurality of repair facilities and instructing reporting to a user the various real-time facility loads.

### BACKGROUND

Currently repair facility locator systems can drive too much volume to top three shops, while leaving excess capacity unused at other shops in the market. This misallocation of work can lead to increases in cycle time, rental duration, and decreased customer satisfaction. While quality and speed of work is important, availability is an additional element needed when identifying facilities for performing work. Existing systems have limited insight into real-time repair facility capacity and current repair facility work in progress (WIP). Driving too much volume to the highest performers in a program can cause those high performers to become overwhelmed. Furthermore, some programs expect priority given to specific customers, where it is difficult to measure whether or not this is being done. Accordingly, it would be desirable to have a system for knowing the real-time capacity of repair facilities.

### BRIEF SUMMARY

The present embodiments may relate to systems and methods for monitoring a plurality of repair facilities. The system may include a repair monitoring (RM) computer system, one or more insurer network computer devices, one or more user devices, and/or one or more repair facility computer devices. The RM computer system may be associated with an insurance network or may be merely in communication with an insurance network.

The RM computer system may be configured to: i) store a plurality of historical vehicle repair information for a plurality of repair facilities; ii) collect a plurality of vehicle repair information from the plurality of repair facilities; iii) for each of the plurality of repair facilities, determine a current load for the corresponding repair facility; iv) receive, from a user computer device, a query for information about one or more repair facilities; v) generate a user interface to include results of the query based on the plurality of historical vehicle repair information and the plurality of vehicle repair information; vi) instruct the user computer device to display the user interface; vii) store the plurality of vehicle repair information from the plurality of repair facilities; viii) analyze the plurality of vehicle repair information; ix) calculate a plurality of metrics based on the analysis of the plurality of vehicle repair information; x) display one or more metrics of the plurality of metrics on the user interface; xi) sort the plurality of vehicle repair information by geographic area; xii) generate the user interface to provide vehicle repair information based on a user selected geographic area; xiii) automatically detect a discrepancy based on the plurality of vehicle repair information; xiv) present the discrepancy via the user interface; xv) determine a current capacity of the plurality of repair facilities based on the plurality of vehicle repair information; xvi) receive a current or future weather condition; xvii) determine a needed capacity based on the current or future weather condition, the plurality of vehicle repair information, and the plurality of historical vehicle repair information; xviii) calculate a current capacity for a repair facility of the plurality of repair facilities based on the calculated capacity and information from the repair facility computer device; xix) instruct the user interface to display the current capacity for the repair facility; xx) calculate a current capacity for a market region including a plurality of repair facilities based on the plurality of calculated capacities and information from the plurality of repair facility computer devices; xxi) instruct the user interface to display the current capacity for the market region; xxii) calculate a current capacity for an entire enterprise including the plurality of repair facilities based on the plurality of calculated capacities and information from the plurality of repair facility computer devices; xxiii) instruct the user interface to display the current capacity for the entire enterprise; xxiv) provide filtering options on the user interface; xxv) receive, from the user computer device, one or more selections of the filtering options via the user interface; xxvi) update the user interface based on the one or more selections of the filtering options; and xxvii) retrieve information to display on the user interface based on the one or more selections of the filtering options

In one aspect, a computer system for monitoring a plurality of repair facilities may be provided. The computer system may include at least one processor (and/or associated transceiver) in communication with at least one memory device. The computer system is in communication with a user computer device associated with a user. The at least one processor (and/or associated transceiver) may be configured or programmed to: i) store a plurality of historical vehicle repair information for a plurality of repair facilities; ii) collect a plurality of vehicle repair information from the plurality of repair facilities; iii) for each of the plurality of repair facilities, determine a current load for the corresponding repair facility; iv) receive, from a user computer device, a query for information about one or more repair facilities; v) generate a user interface to include results of the query based on the plurality of historical vehicle repair information and the plurality of vehicle repair information; and vi) instruct the user computer device to display the user interface. The computer system may have additional, less, or alternate functionality, including that discussed elsewhere herein.

In another aspect, a computer-implemented method for monitoring a plurality of repair facilities may be provided. The method may be implemented on a repair monitoring (“RM”) computer system including at least one processor in communication with at least one memory device. The RM computer system is further in communication with a user computer device associated with a user. The method may include: i) storing a plurality of historical vehicle repair information for a plurality of repair facilities; ii) collecting a plurality of vehicle repair information from the plurality of repair facilities; iii) for each of the plurality of repair facilities, determining a current load for the corresponding repair facility; iv) receiving, from a user computer device, a query for information about one or more repair facilities; v) generating a user interface to include results of the query based on the plurality of historical vehicle repair information and the plurality of vehicle repair information; and vi) instructing the user computer device to display the user interface. The method may have additional, less, or alternate functionality, including that discussed elsewhere herein.

In at least one further aspect, at least one non-transitory computer-readable storage media having computer-executable instructions embodied thereon may be provided. When executed by at least one processor, the computer-executable instructions may cause the processor to: i) store a plurality of historical vehicle repair information for a plurality of repair facilities; ii) collect a plurality of vehicle repair information from the plurality of repair facilities; iii) for each of the plurality of repair facilities, determine a current load for the corresponding repair facility; iv) receive, from a user computer device, a query for information about one or more repair facilities; v) generate a user interface to include results of the query based on the plurality of historical vehicle repair information and the plurality of vehicle repair information; and vi) instruct the user computer device to display the user interface. The computer-executable instructions may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 illustrates a flow chart of an exemplary computer-implemented process for one aspect of the process of monitoring the capacity of repair facilities, in accordance with the present disclosure.

FIG. 2 illustrates a timing diagram for one aspect of the process of monitoring the capacity of repair facilities, in accordance with the present disclosure.

FIG. 3 illustrates a simplified block diagram of an exemplary computer system for implementing the processes shown in FIGS. 1 and 2.

FIG. 4 illustrates an exemplary configuration of a user computer device, in accordance with one embodiment of the present disclosure.

FIG. 5 illustrates an exemplary configuration of a server computer device, in accordance with one embodiment of the present disclosure.

FIG. 6 illustrates a diagram of components of one or more exemplary computing devices that may be used in the system shown in FIG. 3.

FIG. 7 illustrates a view of a user interface for monitoring capacity at repair facilities using the system shown in FIG. 3.

FIG. 8 illustrates a view of a user interface for monitoring capacity at repair facilities in a specific market using the system shown in FIG. 3.

FIG. 9 illustrates a view of a user interface for monitoring capacity at specific repair facility using the system shown in FIG. 3.

FIG. 10 illustrates a view of a dashboard user interface for monitoring capacity at a specific repair facility using the system shown in FIG. 3.

FIG. 11 illustrates a view of a dashboard user interface for monitoring the claims and vehicles being handle at a specific repair facility using the system shown in FIG. 3.

FIG. 12 illustrates an additional view of a dashboard user interface for monitoring capacity at a specific repair facility using the system shown in FIG. 3.

FIG. 13 illustrates a further view of a dashboard user interface for monitoring the claims and vehicles being handle at a specific repair facility using the system shown in FIG. 3.

FIG. 14 illustrates a view of a dashboard user interface 1400 for a specific repair facility using the system 300 (shown in FIG. 3).

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION OF THE DRAWINGS

The present embodiments may relate to, inter alia, systems and methods for monitoring repairs being performed at a plurality of repair facilities and instructing reporting to a user the various repair facility loads. In one exemplary embodiment, the process may be performed by a repair monitoring (“RM”) computer device. In the exemplary embodiment, the RM computer device may be in communication with a plurality of user computer devices, such as a mobile computer device, insurer network computer devices, and repair facility computer devices. In the exemplary embodiment, the RM computer device is in communication with a user computer device, where the RM computer device transmits data, such as a user interface, to the user computer device to be displayed to the user and receives the user's inputs from the user computer device.

In the exemplary embodiment, the RM computer device generates a facility capacity dashboard that integrates cycle times dates provided by repair facilities with estimate assignment data, rental data, and historical trending information to allow for real time capacity monitoring to understand network availability for customers. The dashboard provides multiple filters and sorting to allow users to monitor multiple aspects of the repair process, including, but not limited to, real time assignment volume (drivable/non-drive, by loss type), work in process (WIP) (scheduled, started, completed pending pickup), repairer availability for estimates/repairs, rental management, and timeliness of documentation submission.

In the exemplary embodiment, the RM computer device aggregates data at the shop, market, state, and enterprise level for real time adjustments and decision making to best meet customer needs for inspections and repairs for auto claims, and as a potential weather response.

The RM computer device collects data from a plurality of facilities across the enterprise and stores the data in one or more databases. This allows the RM computer device to generate and populate the dashboard to provide comparisons across multiple vehicle repair facilities.

In the exemplary embodiment, the dashboard could capture and display assignment availability and assignments volume sent (Month/Week/Day) for each repair facility. The RM computer device would allow the user to filter this data by type of damage, vehicle type, certifications required to make the repairs, damage severity, drivable/non-drive, repair vs total loss, and geographic area, such as enterprise, state, city market, and shop level. The dashboard could also capture and display estimates receives on a monthly, weekly, and/or daily basis. The RM computer device could filter the estimates received by type of damage, vehicle type, certifications required for the repairs, damage severity, drivable/non-drive, repair vs total loss, and geographic area, such as enterprise, state, city market, and shop level. The dashboard could also capture and display capture rate (how often work is agreed to after estimate) on a monthly, weekly, and/or daily basis. The RM computer device could filter the capture rate by assignment, estimate rate type of damage, vehicle type, certifications require for repairs, damage severity, drivable/non-drive, repair vs total loss, and geographic area, such as enterprise, state, city market, and shop level.

The RM computer device could also capture information about defect rate and channel switching. Channel switching refers to when the repairer doesn't capture the job, where does it go? Does the vehicle go to another drop location? The RM computer device can capture staff estimates. The RM computer device can further capture self-service information, including photos.

In addition, the RM computer device can calculate aggregate cycle times and/or dates relative to each repair facilities availability and profile. Furthermore, the RM computer device can calculate average cycle times for drivable and non-driving vehicles based on geographic area, such as enterprise, state, city market, and shop level.

Moreover, the RM computer device can calculate the WIP for each repair facility and then compare the WIP based on overall availability/capacity, how many vehicles are scheduled, vehicles where the repairs have been started, when repairs are expected to be completed, when repairs have been completed, where the vehicle has not been picked up yet, and how many slots there are in the repair facility for pending assignments.

In some embodiments, the RM computer device updates the dashboard to include state and market level color coding and screen indicators to provide context on when the user may need to look closer and take action such as when a market area reaches zero appointment availability over the next seven days for estimates or repairs. The RM computer device could also provide additional filters to allow for sorting including, but not limited to, damage severity, weather vs collision, drivable and non-drive, and availability for estimate versus repairs.

In still further embodiments, the dashboard includes headers at the top of each section that would also show graphs to reflect the general “health” of the operation. Examples of this general “health” includes, but it not limited to, capacity pie charts and vehicle trackers at the shop level to visual show where the vehicles are.

In additional embodiments, the RM computer device analyzes multi-shop operations (MSO) load leveling capability, monitoring what is occurring at the MSO level, and the MSOs ability to move work between locations.

In other embodiments, the RM computer device includes the ability to include one or more multipliers into capacity calculation when private inspection facility (PIF) is expected to grow and claim frequency changes in given areas. The dashboard can identify discrepancies when something should be reviewed closer such as: a missing date; a facility or market approaching capacity; an assignment and no estimate received from the shop, but a rental has started; a total loss, but no vehicle data provided for TL handling; and/or a vehicle move date if no repair start date.

The RM computer device can cause the user interface/dashboard to include additional details and/or screens that can be built out to show alternate dashboard views, ties to mapping databases for market identification and weather impact/radius, and/or details on admin items needed for market and shop levels details to populate.

In the exemplary embodiment, the dashboard integrates cycle times based on dates provided by repair facilities with estimate assignment data, rental data, and historical trending information to allow for real time capacity monitoring to understand repair facility availability for customers. Furthermore, as described herein, the dashboard provides multiple filters and sorting to allow operational leaders to understand real time assignment volume (drivable/non-drive, by loss type), WIP (scheduled, started, completed pending pickup), repairer availability for estimates/repairs, rental management, and timeliness of TL documentation submission. The RM computer device aggregates the data at the shop, market, state, and enterprise level for real time adjustments and decision making to best meet customer needs for select services inspections and repairs for auto claims, and as a potential weather response.

In further embodiments, the RM computer device can be used to determine when additional repair facility capacity is needed. For example, if there is growth in the number of automobile insurance policies in a market, the RM computer device can determine when the current amount of repair facility capacity is insufficient based on historical information. Furthermore, the RM computer device can determine when there is excess repair facility capacity where the number of facilities need to be reduced. Furthermore, the RM computer device can use the historical information to determine when more accidents occur and the severity of those accidents to determine seasonal changes in the needed repair facility capacity. Moreover, the RM computer device can also determine when the make-up of the vehicles in an area change, such as through gentrification, causing a need for additional capacity or facilities with specific certifications. In still further embodiments, the RM computer device can generate heat maps of the need versus capacity to show areas where changes are needed and/or happening.

In some embodiments, user interface dashboards may be presented to provide additional information and insights. In these embodiments, the user interface dashboards help manage repair programs. Program Administrator users can utilize the tool to see a daily snapshot of the repair capacity of individual repair facilities, markets, and states. This allows users the ability to better understand program health while making decisions around repair facility additions/removals, repair load-leveling, and coverage during catastrophe events.

In these embodiments, the user interface dashboard consists of four separate pages; Inventory Dashboard, Claim Details, Glossary, and Instructions. The Inventory Dashboard may be the main visual of the report. Utilizing the View Selection buttons and dropdowns, data can be presented at three different levels; State, Market, and Repair Facility. Based on selection, the report will show various metrics and a Capacity Percentage meter. A claim details may be available only when the Repair Facility view is selected. The claim details page may allow the user to better understand which individual vehicles are driving the report. More detailed information around the claim is also presented. A Glossary may also be presented including a listing of all metrics listed in the report, their definition, their source, and any calculations, if applicable. An Instructions page may also be available providing instructions on utilizing the reports.

While the above describe the object to be repaired as being a vehicle, the object may be one of any other object that needs to be analyzed to determine the amount of damage that the object has sustained. In some further embodiments, the object may be, but is not limited to, a personal possession, such as an antique clock, a piece of artwork, and/or a piece of furniture.

### Exemplary Computer-Implemented Method for Monitoring the Capacity of Repair Facilities

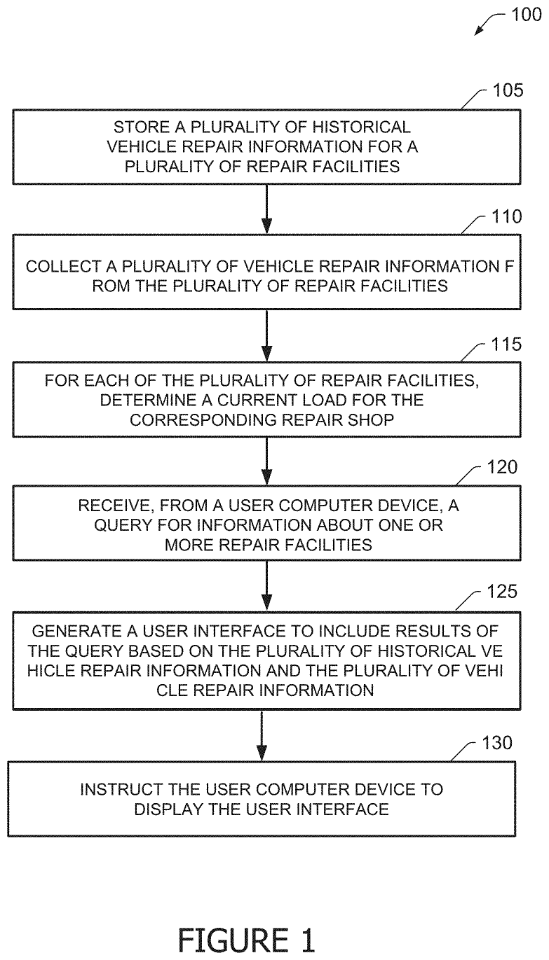

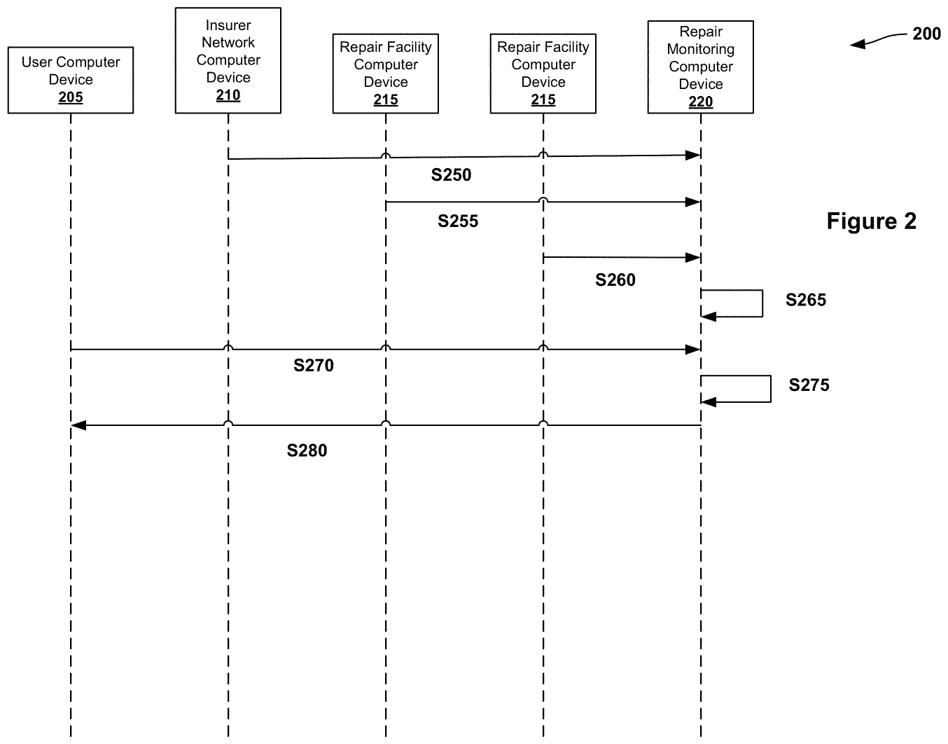

FIG. 1 illustrates a flow chart of an exemplary computer-implemented process 100 for one aspect of the process of monitoring the capacity of repair facilities, in accordance with the present disclosure. In the exemplary embodiment, process 100 is performed by a computer device associated with an insurance provider, such as repair monitoring (RM) computer device 220 (shown in FIG. 2). In other embodiments, process 100 is performed by a computer device in communication with an insurance provider. In the exemplary embodiment, RM computer device 220 is in communication with a user computer device, such as a mobile computer device, for example user computer device 205 (shown in FIG. 2). In this embodiment, RM computer device 220 performs process 100 by transmitting data to the user computer device 205 to be displayed to the user and receives the user's inputs from user computer device 205.

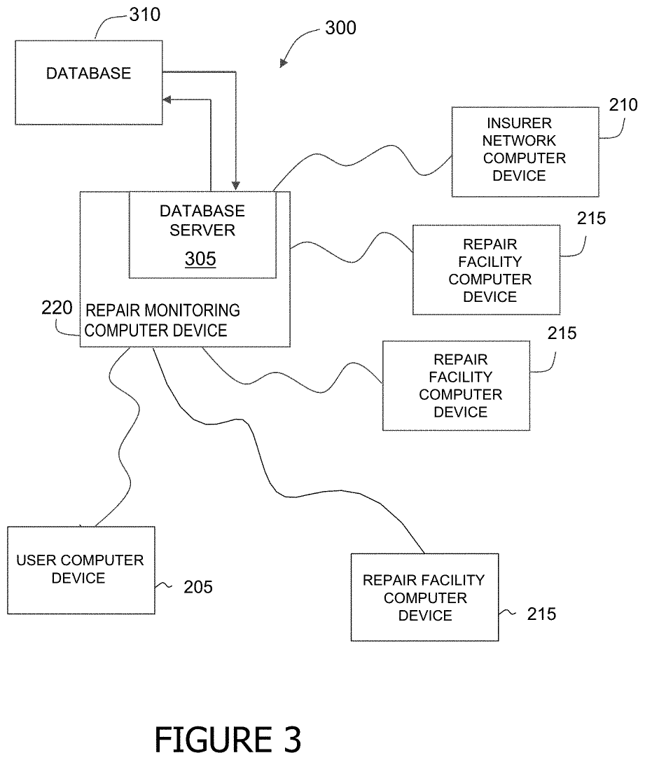

In the exemplary embodiment, the RM computer device 220 stores 105 a plurality of historical vehicle repair information for a plurality of repair facilities. In at least some embodiments, the plurality of historical vehicle repair information is stored in a database, such as database 310 (shown in FIG. 3).

In the exemplary embodiment, the RM computer device 220 collects 110 a plurality of vehicle repair information from the plurality of repair facilities. In some embodiments, the RM computer device 220 is in communication with a plurality of repair facility computer devices 215 (shown in FIG. 2), where each repair facility computer device 215 is associated with at repair facility of the plurality of repair facilities. In other embodiments, the plurality of repair facility computer devices 215 are in communication with the database 310 itself. In still other embodiments, the plurality of repair facility computer devices 215 are in communication with an insurer network computer device 210 and the insurer network computer device 210 receives the vehicle repair information and forwards the vehicle repair information to the database 310 and/or the RM computer device 220. In the exemplary embodiment, the RM computer device 220 stores the plurality of vehicle repair information from the plurality of repair facilities.

For each of the plurality of repair facilities, the RM computer device 220 determines 115 a current load for the corresponding repair facility based on the plurality of data in the database(s) 310. In the exemplary embodiment, the RM computer device 220 receives 120, from a user computer device 205, a query for information about one or more repair facilities. In the exemplary embodiment, the RM computer device 220 generates 125 a user interface to include results of the query based on the plurality of historical vehicle repair information and the plurality of vehicle repair information. In the exemplary embodiment, the RM computer device 220 instructs 130 the user computer device 205 to display the user interface.

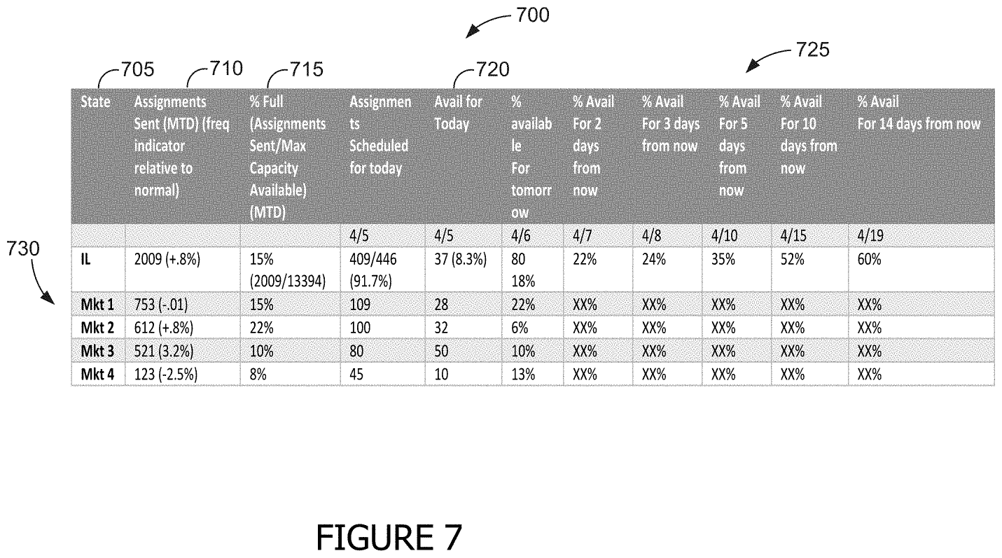

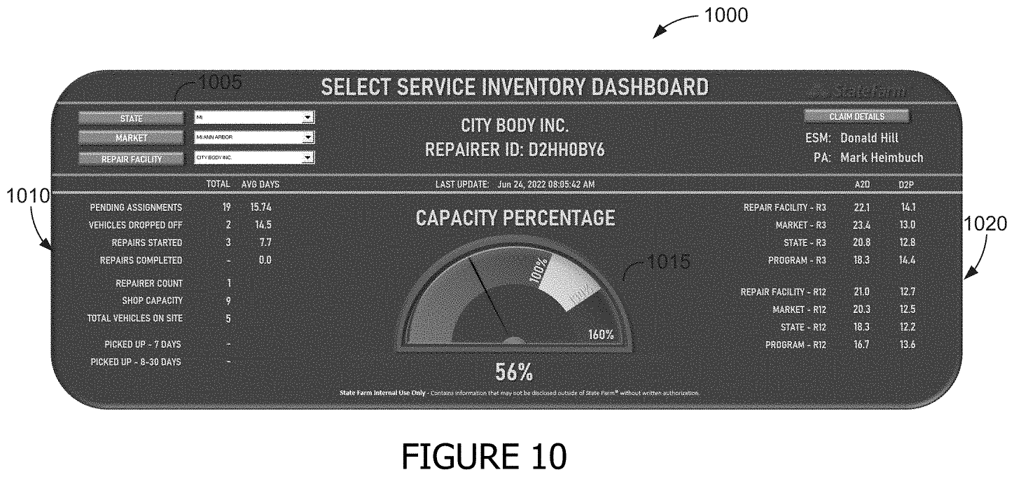

In some embodiments, the RM computer device 220 analyzes the plurality of vehicle repair information. The RM computer device 220 calculates a plurality of metrics based on the analysis of the plurality of vehicle repair information. The RM computer device 220 displays one or more metrics of the plurality of metrics on the user interface. This display may be on a user computer device 205 and/or an insurer network computer device 210. In some of these embodiments, the user interface displays information similar to one or more of the user interfaces shown in FIGS. 7-11. In addition, some of the information is converted to be displayed graphical, such as, but not limited to, the capacity gages 1015 (shown in FIG. 10).

In some embodiments, the RM computer device 220 sorts the plurality of vehicle repair information by geographic area. The RM computer device 220 generates the user interface to provide vehicle repair information based on a user selected geographic area. For example, the geographic area may include, but is not limited to, enterprise, country, state, province, region, county, city, market, and/or individual shop.

In some further embodiments, the RM computer device 220 automatically detects a discrepancy based on the plurality of vehicle repair information. Then the RM computer device 220 presents the discrepancy via the user interface.

In at least some embodiments, the RM computer device 220 determines a current capacity of the plurality of repair facilities based on the plurality of vehicle repair information. In some further embodiments, the RM computer device 220 receives a current or future weather condition. Then the RM computer device 220 determines a needed capacity based on the current or future weather condition, the plurality of vehicle repair information, and the plurality of historical vehicle repair information.

While the above describe repairing vehicles, the object to be repaired may be, but is not limited to, a personal possession, such as an antique clock, a piece of artwork, and/or a piece of furniture.

### Exemplary Process for Monitoring the Capacity of Repair Facilities

FIG. 2 illustrates a timing diagram for one aspect of the process 200 of monitoring the capacity of repair facilities, in accordance with the present disclosure.

Process 200 illustrates the communications between multiple computer devices. More specifically, a user computer device 205, an insurer network computer device 210, a repair facility computer devices 215, and a repair monitoring (“RM”) computer device 220. In the exemplary embodiment, RM computer device 220 may be in communication with one or more user computer devices 205, such as a mobile computer device, one or more insurer network computer devices 210, and a plurality of repair facility computer devices 215. In some embodiments, RM computer device 220 is in communication with another RM computer device 220. In some of these embodiments, each RM computer device 220 is assigned to monitor the repair facilities in a specific geographic area.

In step S250, the insurer network computer device 210 transmits information to the RM computer device 220. The information can include, but is not limited to, claims information, assignment information, information about relationships with different repair facilities, and other information as described herein. In steps S255 and 260, vehicle repair information is provided from the repair facility computer devices 215 to the RM computer device 220. The vehicle repair information includes information about current capabilities of the repair facility and those vehicles that are currently at or have received estimates from the repair facility.

In step S265, the RM computer device 220 stores and analyzes the data. The RM computer device 220 performs calculations to determine percentages of capacity available and used by each repair facility as well as forecasting that capacity out for a period of time, such as two weeks.

In the exemplary embodiment, steps S250 through S265 are being performed on a constant basis, such that repair facility computer devices 215 are providing up-to-date information to the RM computer device 220 and the RM computer device 220 is updating its analysis based on the currently provided information.

In step S270, a user computer device 205 requests information from the RM computer device 220. In response, in step S275, the RM computer device 220 generates an updated user interface based on the request. In step S280, the RM computer device 220 provides the updated user interface to the user computer device 205. In the exemplary embodiment, the user computer device 205 may refine its request to include updated/filtered/sorted/drilled down information. The RM computer device 220 then further updates the user interface it provides to the user computer device 205. In some of these embodiments, the user interface displays information similar to one or more of the user interfaces shown in FIGS. 7-11. In addition, some of the information is converted to be displayed graphical, such as, but not limited to, the capacity gages 1015 (shown in FIG. 10).

### Exemplary Computer Network

FIG. 3 depicts a simplified block diagram of an exemplary computer system 300 for implementing process 100 (shown in FIG. 1) and process 200 (shown in FIG. 2). In the exemplary embodiment, computer system 300 may be used for monitoring vehicle repairs across multiple repair facilities. As described below in more detail, a repair monitoring (“RM”) computer device 220 may be configured to (i) store a plurality of historical vehicle repair information for a plurality of repair facilities; (ii) collect a plurality of vehicle repair information from the plurality of repair facilities; (iii) for each of the plurality of repair facilities, determine a current load for the corresponding repair facility; (iv) receive, from a user computer device 205 a query for information about one or more repair facilities; (v) generate a user interface to include results of the query based on the plurality of historical vehicle repair information and the plurality of vehicle repair information; and (vi) instruct the user computer device 205 to display the user interface.

In the exemplary embodiment, user computer devices 205 are computers that include a web browser or a software application, which enables user computer devices 205 to access remote computer devices, such as RM computer device 220 and insurer network computer devices 210, using the Internet or other network. More specifically, user computer devices 205 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. User computer devices 205 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices.

A database server 305 may be communicatively coupled to a database 310 that stores data. In one embodiment, database 310 may include vehicle information, select service locations, claims inspection sites, and repair facility information, both historical and current. In the exemplary embodiment, database 310 may be stored remotely from RM computer device 220. In some embodiments, database 310 may be decentralized. In the exemplary embodiment, the user may access database 310 via user computer device 205 by logging onto RM computer device 220, as described herein.

RM computer device 220 may be communicatively coupled with one or more user computer devices 205. In some embodiments, RM computer device 220 may be associated with, or is part of a computer network associated with an insurance provider, or in communication with insurer network computer devices 210. In other embodiments, RM computer device 220 may be associated with a third party and is merely in communication with the insurer network computer devices 210. More specifically, RM computer device 220 is communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. RM computer device 220 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In the exemplary embodiment, RM computer device 220 hosts an application or website that allows the user to access the functionality described herein. In some further embodiments, user computer device 205 includes an application that facilitates communication with RM computer device 220.

In the exemplary embodiment, insurer network computer devices 210 include one or more computer devices associated with an insurance provider. In the exemplary embodiment, insurance provider is associated with the user and the user has an insurance policy that insures the object with insurance provider. In the exemplary embodiment, insurer network computer devices 210 include a web browser or a software application, which enables insurer network computer devices 210 to access remote computer devices, such as RM computer device 220 and database server 305, using the Internet or other network. More specifically, insurer network computer devices 210 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Insurer network computer devices 210 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, insurer network computer devices 210 may access database 310 to analyze repairs, vehicles, claims, and/or repair facility information.

In the exemplary embodiment, repair facility computer devices 215 include computer devices associated with repair facilities capable of repairing a vehicle or other object. In the exemplary embodiment, repair facility computer devices 215 include a web browser or a software application, which enables repair facility computer devices 215 to access remote computer devices, such as RM computer device 220, using the Internet or other network. More specifically, repair facility computer devices 215 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem. Repair facility computer devices 215 may be any device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. In some embodiments, repair facility computer devices 215 may communicate with RM computer device 220 to schedule repair appointments. In some embodiments, repair facilities also function as inspection sites. In these embodiments, repair facility computer devices 215 may communicate with RM computer device 220 to provide information and/or storing information in the database 310. Repair facility computer devices 215 may communicate with database 310 to provide updates about a vehicle being repaired.

### Exemplary Client Device

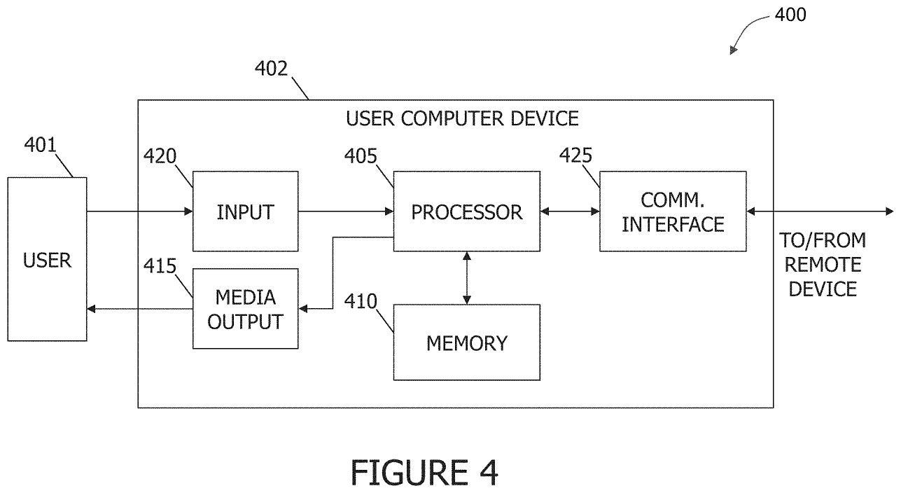

FIG. 4 depicts an exemplary configuration 400 of user computer device 402, in accordance with one embodiment of the present disclosure. In the exemplary embodiment, user computer device 402 may be similar to, or the same as, user computer device 205 (shown in FIG. 2). User computer device 402 may be operated by a user 401. User computer device 402 may include, but is not limited to, user computer devices 205, insurer network computer devices 210, and repair facility computer devices 215 (all shown in FIG. 2). User computer device 402 may include a processor 405 for executing instructions. In some embodiments, executable instructions may be stored in a memory area 410. Processor 405 may include one or more processing units (e.g., in a multi-core configuration). Memory area 410 may be any device allowing information such as executable instructions and/or repair data to be stored and retrieved. Memory area 410 may include one or more computer readable media.

User computer device 402 may also include at least one media output component 415 for presenting information to user 401. Media output component 415 may be any component capable of conveying information to user 401. In some embodiments, media output component 415 may include an output adapter (not shown) such as a video adapter and/or an audio adapter. An output adapter may be operatively coupled to processor 405 and operatively coupleable to an output device such as a display device (e.g., a cathode ray tube (CRT), liquid crystal display (LCD), light emitting diode (LED) display, or “electronic ink” display) or an audio output device (e.g., a speaker or headphones).

In some embodiments, media output component 415 may be configured to present a graphical user interface (e.g., a web browser and/or a client application) to user 401. A graphical user interface may include, for example, an interface for viewing repair facility locations. In some embodiments, user computer device 402 may include an input device 420 for receiving input from user 401. User 401 may use input device 420 to, without limitation, select a repair facility to view information about.

Input device 420 may include, for example, a keyboard, a pointing device, a mouse, a stylus, a touch sensitive panel (e.g., a touch pad or a touch screen), a gyroscope, an accelerometer, a position detector, a biometric input device, and/or an audio input device. A single component such as a touch screen may function as both an output device of media output component 415 and input device 420.

User computer device 402 may also include a communication interface 425, communicatively coupled to a remote device such as RM computer device 220 (shown in FIG. 2). Communication interface 425 may include, for example, a wired or wireless network adapter and/or a wireless data transceiver for use with a mobile telecommunications network.

Stored in memory area 410 are, for example, computer readable instructions for providing a user interface to user 401 via media output component 415 and, optionally, receiving and processing input from input device 420. A user interface may include, among other possibilities, a web browser and/or a client application. Web browsers enable users, such as user 401, to display and interact with media and other information typically embedded on a web page or a website from RM computer device 22. A client application may allow user 401 to interact with, for example, RM computer device 220. For example, instructions may be stored by a cloud service, and the output of the execution of the instructions sent to the media output component 415.

### Exemplary Server Device

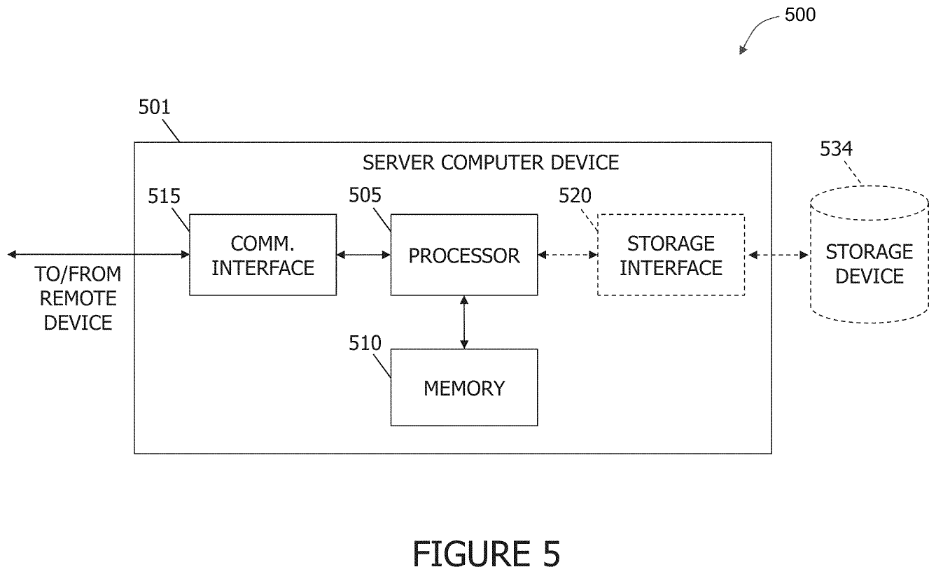

FIG. 5 depicts an exemplary configuration 500 of a server computer device 501, in accordance with one embodiment of the present disclosure. In the exemplary embodiment, server computer device 501 may be similar to, or the same as, RM computer device 220 (shown in FIG. 2). Server computer device 501 may include, but is not limited to, RM computer device 220, insurer network computer devices 210, repair facility computer device 215 (all shown in FIG. 2), and database server 305 (shown in FIG. 3). Server computer device 501 may also include a processor 505 for executing instructions. Instructions may be stored in a memory area 510. Processor 505 may include one or more processing units (e.g., in a multi-core configuration).

Processor 505 may be operatively coupled to a communication interface 515 such that server computer device 501 is capable of communicating with a remote device such as another server computer device 501, RM computer device 220, insurer network computer devices 210, repair facility computer device 215, and user computer devices 205 (shown in FIG. 2) (for example, using wireless communication or data transmission over one or more radio links or digital communication channels). For example, communication interface 515 may receive requests from user computer devices 205 via the Internet, as illustrated in FIG. 3.

Processor 505 may also be operatively coupled to a storage device 534. Storage device 534 may be any computer-operated hardware suitable for storing and/or retrieving data, such as, but not limited to, data associated with database 310 (shown in FIG. 3). In some embodiments, storage device 534 may be integrated in server computer device 501. For example, server computer device 501 may include one or more hard disk drives as storage device 534.

In other embodiments, storage device 534 may be external to server computer device 501 and may be accessed by a plurality of server computer devices 501. For example, storage device 534 may include a storage area network (SAN), a network attached storage (NAS) system, and/or multiple storage units such as hard disks and/or solid state disks in a redundant array of inexpensive disks (RAID) configuration.

In some embodiments, processor 505 may be operatively coupled to storage device 534 via a storage interface 520. Storage interface 520 may be any component capable of providing processor 505 with access to storage device 534. Storage interface 520 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 505 with access to storage device 534.

Processor 505 may execute computer-executable instructions for implementing aspects of the disclosure. In some embodiments, the processor 505 may be transformed into a special purpose microprocessor by executing computer-executable instructions or by otherwise being programmed. For example, the processor 505 may be programmed with the instruction such as illustrated in FIGS. 1 and 2.

### Exemplary Computer Device

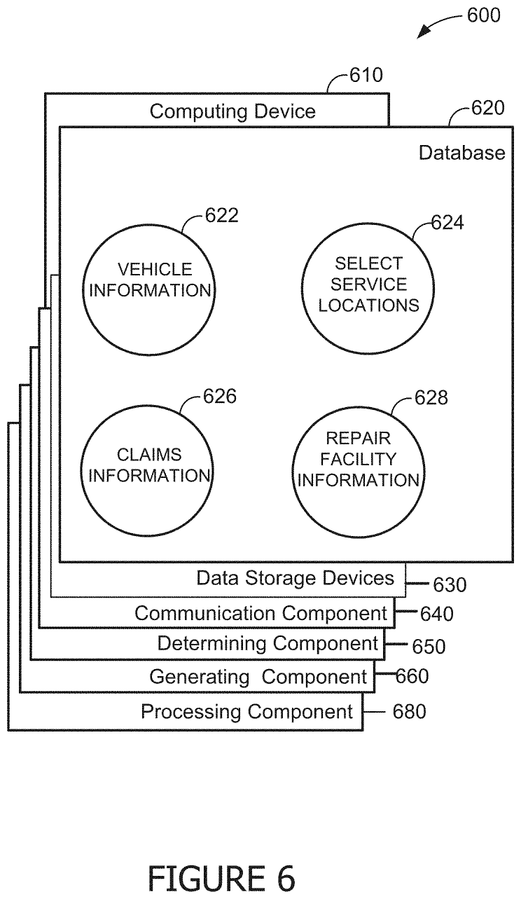

FIG. 6 depicts a diagram 600 of components of one or more exemplary computing devices 610 that may be used in system 300 shown in FIG. 3. In some embodiments, computing device 610 may be similar to RM computer device 220. Database 620 may be coupled with several separate components within computing device 610, which perform specific tasks. In this embodiment, database 620 may include vehicle information 622, select service locations 624, claims information 626, and repair facility information 628. In some embodiments, database 620 is similar to database 310 (shown in FIG. 3).

Computing device 610 may include the database 620, as well as data storage devices 630. Computing device 610 may also include a communication component 640 for collecting 110 a plurality of vehicle repair information from the plurality of repair facilities, receiving 120, from a user computer device 205, a query for information about one or more repair facilities, and instructing 130 the user computer device 205 to display the user interface (all shown in FIG. 1). Computing device 610 may further include a determining component 650 for determining 115 a current load for the corresponding repair facility for each of the plurality of repair facilities (shown in FIG. 1). Moreover, computing device 610 may include a generating component 660 for generating 125 a user interface to include results of the query based on the plurality of historical vehicle repair information and the plurality of vehicle repair information (shown in FIG. 1). A processing component 670 may assist with execution of computer-executable instructions associated with the system.

### Exemplary User Interface

FIG. 7 illustrates a view 700 of a user interface for monitoring capacity at repair facilities using the system 300 (shown in FIG. 3). In the exemplary embodiment, view 700 of user interface is displayed on user computer device 205 (shown in FIG. 2).

View 700 displays a table of shop assignments and capacities for a specific area. View 700 displays columns including, but not limited to, market 705, assignments sent 710 to that market, percentage that each market is full 715, market availability for today 720, and columns for percentage of market availability 725 for different numbers of days in the future. View 700 displays the information for the state of IL for a two-week period in April. In this case, the state has been broken into four market regions 730. The information in view 700 can be filtered and/or sorted as the user desires. The user interface displays the numbers for each market region 730 and for the state overall. In this view 700, the following information is categorized: assignments sent 710, percentage full 715, assignments scheduled for today, available spaces for today 720, percentage available 725 for tomorrow, for two days from today, for three days, for five days, for ten days, and for fourteen days, etc.

### Exemplary User Interface

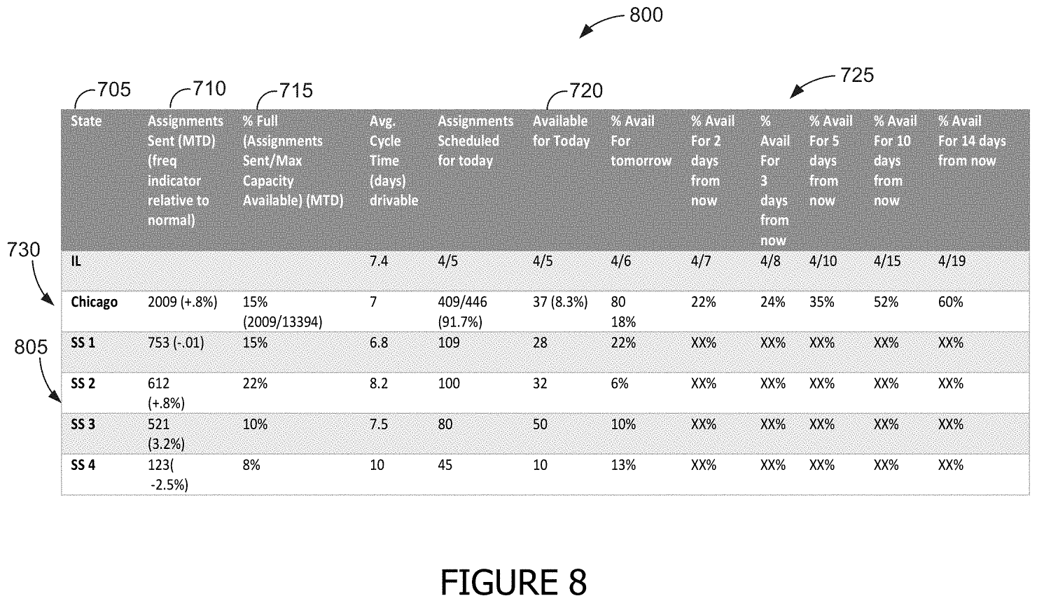

FIG. 8 illustrates a view 800 of a user interface for monitoring capacity at repair facilities in a specific market using the system 300 (shown in FIG. 3). In the exemplary embodiment, view 800 of user interface is displayed on user computer device 205 (shown in FIG. 2).

View 800 displays a table of shop assignments and capacities for a specific area. View 800 displays the drilled down information for Market 1 730 that is shown in view 700 (both shown in FIG. 7). In this embodiment, Market 1 730 is the city of Chicago, Ill. The user interface displays the numbers for subsections or individual repair facilities 805 of Chicago, wherein the subsections or individual repair facilities 805 each include a plurality of repair facilities in the market region 730. The information in view 800 can be filtered and/or sorted as the user desires. In this view 800, the following information is categorized: assignments sent 710, percentage full 715, assignments scheduled for today, available spaces for today 720, percentage available 725 for tomorrow, for two days from today, for three days, for five days, for ten days, and for fourteen days, etc.

### Exemplary User Interface

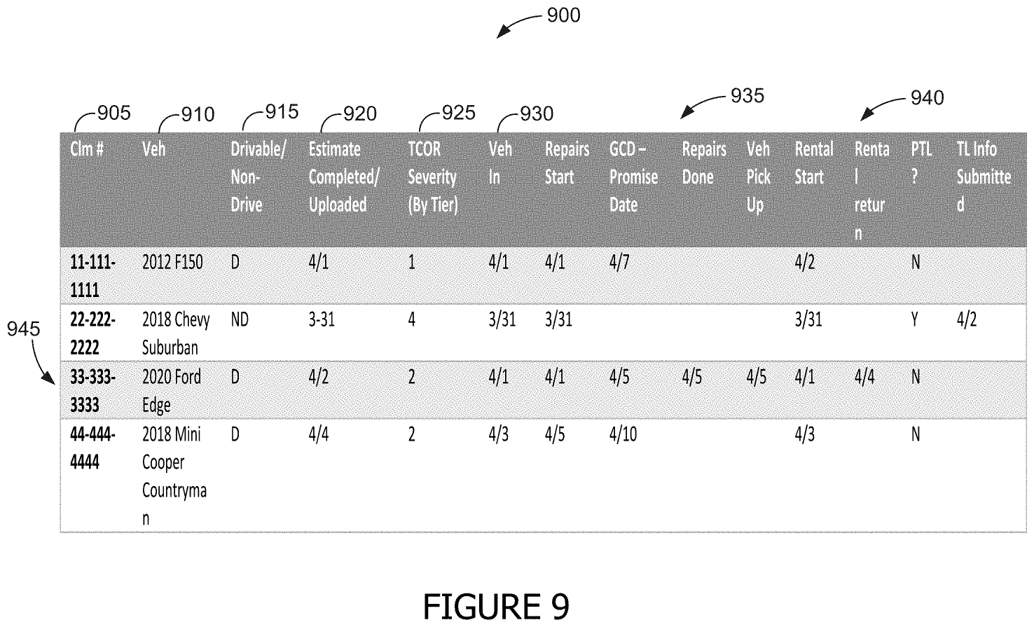

FIG. 9 illustrates a view 900 of a user interface for monitoring capacity at specific repair facility using the system 300 (shown in FIG. 3). In the exemplary embodiment, view 900 of user interface is displayed on user computer device 205 (shown in FIG. 2).

View 900 displays a table of facility information for a selected repair facility. View 900 displays columns including, but not limited to, claim number 905, vehicle type 910, whether or not the vehicle is drivable 915, when the estimate was complete 920, severity of damage 925, when the vehicle arrived 930, repair information 935, and rental vehicle information 940. View 900 displays the drilled down information for a repair facility in Market 1 730 that is shown in view 800 (shown in FIG. 8). The information is broken down by individual claim 945. The information in view 900 can be filtered and/or sorted as the user desires.

The user interface displays the information about each vehicle at the selected repair facility. In this view 900, the following information is categorized: claim number 905, vehicle type 910, date of estimate completion/uploading 920, total cost of repair severity 925, date vehicle in 930, date repair states 935, vehicle promise date 935, date repairs complete 935, date vehicle was picked up 935, date rental started 940, date rental returned 940, total loss, and date of total loss subcommittee.

### Exemplary User Interface

FIG. 10 illustrates a view of a dashboard user interface 1000 for monitoring capacity at a specific repair facility using the system 300 (shown in FIG. 3). In the exemplary embodiment, dashboard user interface 1000 is generated by the RM computer device 220 and transmitted to the user computer device 205 (shown in FIG. 2) to be displayed to the user. The dashboard user interface 1000 is configured to provide information quickly and efficiently to the user. In some embodiments, the dashboard user interface 1000 is customizable to the user. In these embodiments, the RM computer device 220 may customize the dashboard user interface 1000 based on the information that the user is authorized to access, such as due to their role. In one embodiment, the user may be an insurance adjuster. In another embodiment, the user may be a customer searching for a repair facility. In a further embodiment, the user may be associated with a repair facility to determine the capacity at their repair facility.

The dashboard user interface 1000 assists in managing repair programs. Program Administrator users can utilize the tool to see a daily snapshot of the repair capacity of individual repair facilities, markets, and states. This allows users the ability to better understand program health while making decisions around repair facility additions/removals, repair load-leveling, and coverage during catastrophe events.

In the dashboard user interface 1000, the user may also use one or more options 1005 to filter the information that is shown by the dashboard user interface 1000. For example, the user may use the options 1005 to filter to select the state, the market, and/or the individual repair facility to analyze or view. The data may be presented at the state, market, and repair facility levels. Based on the selections in the options 1005, the report may show various metrics and the capacity percentage on a capacity gage 1015.

The dashboard user interface 1000 also includes and displays information 1010 about the selected state, market, and/or repair facility. In the exemplary embodiment, the RM computer device 220 retrieves the desired information from the database 310 (shown in FIG. 3) and performs any calculations needed to add to the information 1010.

While some of the information 1010 is shown being displayed numerically. The dashboard user interface 1000 also displays one or more graphical icons 1015, such as, but not limited to, a capacity gage 1015. The RM computer device 220 combines information to display the graphical icons 1015 to present information in an easily digestible format. Other graphical icons 1015 can include, but are not limited to, color coding the information 1010 based on predetermined thresholds, bar charts, graphs, and/or other graphical presentation of information.

The dashboard user interface 1000 may also display overall repair information 1020, which provides information for comparison purposes, such as, but not limited to, comparing to other individual repair facilities, the overall market, and/or the overall state.

In some embodiments, the data for the RM computer device 220 and the dashboard user interface 1000 is extracted on a periodic basis. The periodic basis may be daily, hourly, multiple times per week, after a predetermined period of time, and/or any other period that allows the RM computer device 220 and/or the dashboard user interface 1000 to work as described herein. In some of these embodiments, the data is extracted at night when the repair facilities are generally closed to reduce load issues on the system.

In at least one embodiment, the RM computer device 220 retrieves all assignments are pulled for the last 1,000 days for the entire Enterprise from one or more databases 310 (shown in FIG. 1). The RM computer device 220 then combines the retrieved assignments to all auto claims for the last 2,000 days. If the two match, and the claim meets the following criteria, the vehicle remains on the report. Otherwise, it is removed.

In at least one embodiment, the criteria may include, but is not limited to, a) the claim is in an open/reopen status; b) the claim is in a closed status, but the vehicle repair status is one of Repair Started, Repair Completed, Vehicle Picked Up—7 Days, or Vehicle Picked Up 8-30 days; c) the claim is in a closed status, but the vehicle repair status is Vehicle Dropped Of and has not moved into Repair Started status within 120 days; d) the applicable Cause Of Loss has to be in an open/reopen status (not paid, etc.); e) the claim cannot have a Salvage Assign date; and f) there cannot be another service assignment sent on a date after the date of the service assignment. If an estimate has been written on the vehicle, the RM computer device 220 brings that data into the dataset. Additionally, the RM computer device 220 retrieves and utilizes any repair-facility entered repair events to place the vehicle into a repair stages: a) Pending Assignment: Assignment sent, but vehicle has not been dropped off; b) Vehicle Drop Off: Vehicle dropped off to repair facility, but repairs have not started; c) Repair Start: Repairs are in progress; d) Repair Complete: Repairs are complete, but vehicle has not been picked up from repair facility; e) Vehicle Picked Up—7 Days: The vehicle has been picked up from the repair facility within the last 7 days; and f) Vehicle Picked Up—8-30 Days: The vehicle has been picked up from the repair facility within the last 8-30 days.

Repair Events are date/time stamps that are provided by the repair facility to help the repair facility, insurance carrier, and customer better understand what stage a vehicle is in during the repair process. The repair event date/time stamps are entered by the repair facility computer device 215. From there, the date is nearly immediately transferred to the database 310 and/or RM computer device 220 via an API protocol.

The repair events may include, but are not limited to, vehicle drop off, repair start, repair complete, vehicle pick up, and/or promise date.

The Capacity Percentage calculation, which is used for the capacity gage 1015, analyzes the total number of vehicles that are currently at the repair facility (as reported by the repair facility computer devices 215 utilizing the forementioned repair events) divided by the repair facility's capacity (which is also reported by the repair facility). This provides a percentage which can be used to better understand if the repair facility has capacity to handle additional repairs. Please note that this value does not take into account repairs that are not reported via the repair facility computer device 215.

Additionally, other data points, may be calculated by the RM computer device 220 and/or other systems for other reports, may presented as reference points. These may include, for example, Average Assignment to Drop Days and Average Drop to Pickup Days, for rolling 3 and 12 months. In some embodiments, these are calculated monthly.

### Exemplary User Interface

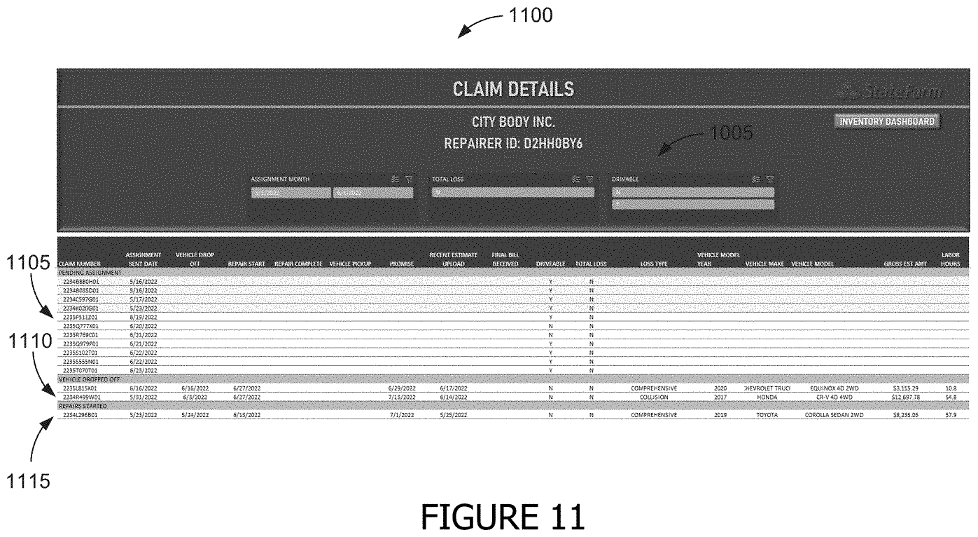

FIG. 11 illustrates a view of a dashboard user interface 1100 for monitoring the claims and vehicles being handle at a specific repair facility using the system 300 (shown in FIG. 3). In the exemplary embodiment, dashboard user interface 1100 is generated by the RM computer device 220 and transmitted to the user computer device 205 (shown in FIG. 2) to be displayed to the user. The dashboard user interface 1100 is configured to provide information quickly and efficiently to the user. In some embodiments, the dashboard user interface 1100 is customizable to the user. In these embodiments, the RM computer device 220 may customize the dashboard user interface 1100 based on the information that the user is authorized to access, such as due to their role.

The dashboard user interface 1100 allows the user to better understand which individual vehicles are driving the report. More detailed information around the claim is also presented.

The dashboard user interface 1100 includes filterable options 1005 that allow the user to select the attributes of information that the user desires to display. The dashboard user interface 1100 can display claims pending assignment 1105, claims where the vehicle has been dropped off 1110, and claims where the repair has started 1115. The dashboard user interface 1100 can display more or less information based on the filterable options 1005 that have selected by the user.

### Exemplary User Interface

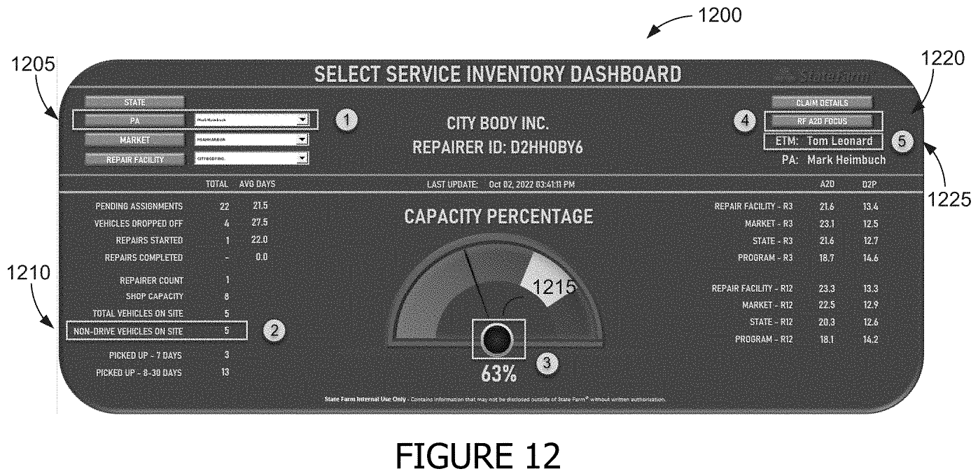

FIG. 12 illustrates am additional view of a dashboard user interface 1200 for monitoring capacity at a specific repair facility using the system 300 (shown in FIG. 3). In the exemplary embodiment, dashboard user interface 1200 is generated by the RM computer device 220 and transmitted to the user computer device 205 (shown in FIG. 2) to be displayed to the user. The dashboard user interface 1200 is configured to provide information quickly and efficiently to the user. In some embodiments, the dashboard user interface 1200 is customizable to the user. In these embodiments, the RM computer device 220 may customize the dashboard user interface 1200 based on the information that the user is authorized to access, such as due to their role. In one embodiment, the user may be an insurance adjuster. In another embodiment, the user may be a customer searching for a repair facility. In a further embodiment, the user may be associated with a repair facility to determine the capacity at their repair facility.

Program Administrator users can utilize the tool to see a daily snapshot of the repair capacity of individual repair facilities, markets, and states. This allows users the ability to better understand program health while making decisions around repair facility additions/removals, repair load-leveling, and coverage during catastrophe events.

Dashboard user interface 1200 adds additional information over dashboard user interface 1000 (shown in FIG. 10). First, dashboard user interface 1200 adds a Program Administrator (PA) button 1205 and a PA dropdown menu 1210. Clicking the PA Button 1205 allows the user to display the PA view, which provides an overview of all repair facilities assigned to the selected Program Administrator. The PA Dropdown menu 1210 provides further filtering to markets and repair facilities assigned only to the selected Program Administrator.

The dashboard user interface 1200 also added a Non-Drive Vehicles On Site measurement 1215, which counts all of the non-drivable vehicles currently sitting at a repair facility. If Market, PA, or State views are selected, the non-drivable vehicles value is summed to that level.

The dashboard user interface 1200 further added a B2B toggle indicator light 1220. Available only at the Repair Facility view, the B2B toggle indicator light 1220 will illuminate red if the selected repair facility is currently declining Select Service assignments via the B2B On/Off Toggle.

In addition, the dashboard user interface 1200 adds a Repair Facility (RF) A2D Focus button 1225, which allows the user access to vie the RF A2D Focus page of the user interface. A2D stands for assignment to drop and is the time from when the assignment is sent until when the vehicle is dropped off. The RF A2D Focus button 1225 can be relabeled and retargeted to other screens based on the permissions, access, and needs of the user.

Furthermore, the dashboard user interface 1200 replaces the Enterprise Service Manager (ESM) with the Estimatics Team Manager (ETM) assigned to the selected repair facility.

### Exemplary User Interface

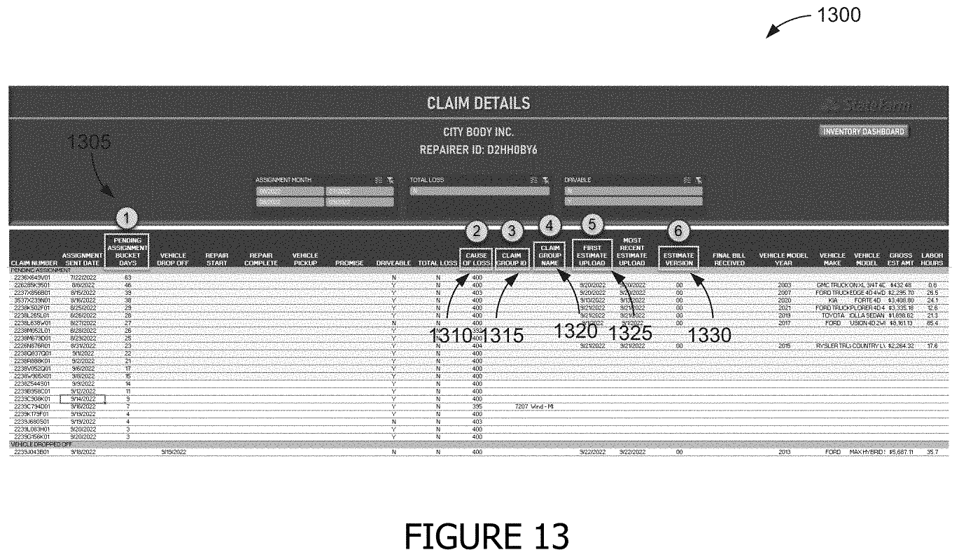

FIG. 13 illustrates a further view of a dashboard user interface 1300 for monitoring the claims and vehicles being handle at a specific repair facility using the system 300 (shown in FIG. 3). In the exemplary embodiment, dashboard user interface 1300 is generated by the RM computer device 220 and transmitted to the user computer device 205 (shown in FIG. 2) to be displayed to the user. The dashboard user interface 1300 is configured to provide information quickly and efficiently to the user. In some embodiments, the dashboard user interface 1300 is customizable to the user. In these embodiments, the RM computer device 220 may customize the dashboard user interface 1300 based on the information that the user is authorized to access, such as due to their role.

The dashboard user interface 1300 allows the user to better understand which individual vehicles are driving the report. More detailed information around the claim is also presented.

Dashboard user interface 1300 adds additional information over dashboard user interface 1100 (shown in FIG. 11). First, dashboard user interface 1300 adds a Pending Assignment Bucket Days measurement 1305, which displays the number of days that a vehicle has remained in the Pending Assignments bucket. The dashboard user interface 1300 also adds a Cause of Loss measurement 1310, which displays the Cause of Loss as listed in ECS for the claim/vehicle number. The dashboard user interface 1300 further adds a Claim Group ID measurement 1315, which displays the Claim Group ID as listed in ECS, if applicable. In addition, the dashboard user interface 1300 adds a Claim Group Name measure 1320, which displays the Claim Group Name as listed in ECS, if applicable. Moreover, the dashboard user interface 1300 adds a First Estimate Upload measurement 1325, which displays the date of first estimate upload on vehicle from listed repair facility. Furthermore, the dashboard user interface 1300 adds an Estimate Version measurement 1330, which display an Estimate Version of most recent estimate uploaded on vehicle from listed repair facility.

### Exemplary User Interface

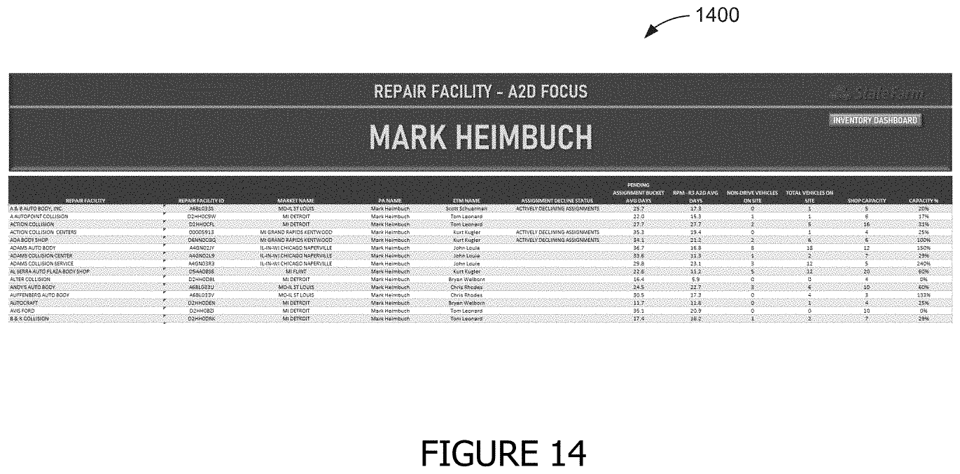

FIG. 14 illustrates a view of a dashboard user interface 1400 for a specific repair facility using the system 300 (shown in FIG. 3). In the exemplary embodiment, dashboard user interface 1400 is generated by the RM computer device 220 and transmitted to the user computer device 205 (shown in FIG. 2) to be displayed to the user. The dashboard user interface 1400 is configured to provide information quickly and efficiently to the user. In some embodiments, the dashboard user interface 1400 is customizable to the user. In these embodiments, the RM computer device 220 may customize the dashboard user interface 1400 based on the information that the user is authorized to access, such as due to their role. In some embodiments, dashboard user interface 1400 is opened by pressing the RF A2D Focus button 1225.

Repair Facility—A2D Focus dashboard user interface 1400 displays a list of repair facilities where the Pending Assignment Bucket Avg Days is greater than the RPM A2D Avg Days. The list of repair facilities will update based on the selected view. This allows users to quickly see if repair facilities are potentially falling behind on future repairs based on their normal Assignment to Drop average days.

### Exemplary Embodiments & Functionality

In one aspect, a computer system for monitoring a plurality of repair facilities may be provided. The computer system may include at least one processor in communication with at least one memory device. The computer system may be in communication with a user computer device associated with a user. The at least one processor may be configured or programmed to: (1) store a plurality of historical vehicle repair information for a plurality of repair facilities; (2) collect a plurality of vehicle repair information from the plurality of repair facilities; (3) for each of the plurality of repair facilities, determine a current load for the corresponding repair facility; (4) receive, from a user computer device, a query for information about one or more repair facilities; (5) generate a user interface to include results of the query based on the plurality of historical vehicle repair information and the plurality of vehicle repair information; and (6) instruct the user computer device to display the user interface. A further enhancement may be where the computer system may store the plurality of vehicle repair information from the plurality of repair facilities.

In a further enhancement, the computer system may analyze the plurality of vehicle repair information. The computer system may further calculate a plurality of metrics based on the analysis of the plurality of vehicle repair information. The computer system may also display one or more metrics of the plurality of metrics on the user interface.

In yet a further enhancement, the computer system may sort the plurality of vehicle repair information by geographic area. The computer system may further generate the user interface to provide vehicle repair information based on a user selected geographic area.

A further enhancement may be where the computer system may automatically detect a discrepancy based on the plurality of vehicle repair information. The computer system may then present the discrepancy via the user interface.

An additional enhancement may be wherein the computer system may determine a current capacity of the plurality of repair facilities based on the plurality of vehicle repair information. The computer system may also receive a current or future weather condition. The computer system may further determine a needed capacity based on the current or future weather condition, the plurality of vehicle repair information, and the plurality of historical vehicle repair information. The computer system may calculate a current capacity for a repair facility of the plurality of repair facilities based on the calculated capacity and information from the repair facility computer device. The computer system may also instruct the user interface to display the current capacity for the repair facility. The computer system may calculate a current capacity for a market region including a plurality of repair facilities based on the plurality of calculated capacities and information from the plurality of repair facility computer devices. The computer system may further instruct the user interface to display the current capacity for the market region. Additionally, the computer system may calculate a current capacity for an entire enterprise including the plurality of repair facilities based on the plurality of calculated capacities and information from the plurality of repair facility computer devices. Furthermore, the computer system may instruct the user interface to display the current capacity for the entire enterprise.

A further enhancement may be wherein the computer system may provide filtering options on the user interface. The computer system may also receive, from the user computer device, one or more selections of the filtering options via the user interface. The computer system may further update the user interface based on the one or more selections of the filtering options.

Moreover, an enhancement may be wherein the computer system may retrieve information to display on the user interface based on the one or more selections of the filtering options.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as image data of objects to be analyzed (e.g., vehicle damage), mobile device data, and/or vehicle telematics data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the object, vehicle, user, damage, needed repairs, costs and/or incident from vehicle data, insurance policies, geolocation data, image data, and/or other data.

In the exemplary embodiment, a processing element may be trained by providing it with a large sample of repair and vehicle damage data with known characteristics or features. Such information may include, for example, information associated with a shape, size, and/or type of damage as well as the qualifications of various repair facilities and past choices of users related to different repair facilities based on information such as insurance policies, geolocation data, image data, and/or other data.

Based upon these analyses, the processing element may learn how to identify characteristics and patterns that may then be applied to analyzing repair data. For example, the processing element may learn, with the user's permission or affirmative consent, to identify the repair facilities most appropriate for certain types of vehicles and certain types of damages. The processing element may also learn how to identify attributes of different repair facilities to determine whether or not to keep or drop a specific repair facility and whether to add repair facilities based on weather conditions.

### Technical Advantages

The aspects described herein may be implemented as part of one or more computer components such as a client device and/or one or more back-end components, such as a repair assessment engine, for example. Furthermore, the aspects described herein may be implemented as part of a computer network architecture and/or a cognitive computing architecture that facilitates communications between various other devices and/or components. Thus, the aspects described herein address and solve issues of a technical nature that are necessarily rooted in computer technology.

For instance, aspects include analyzing various sources of data to determine up to date, real-time capacity and capabilities of repair facilities to correctly direct users in need of repairs. In doing so, the aspects overcome issues associated with the inconvenience of manually contacting repair facilities to determine their current capacity and whether or not they can repair additional vehicles. Without the improvements suggested herein, additional processing and memory usage would be required to perform such coordination. Additional technical advantages include, but are not limited to: i) improved speed and responsiveness in repairing an object; ii) preventing the repair process from being hung up by a dropped step; iii) monitoring the repair process across multiple repair facilities; iv) allowing for real-time analysis of the current availability of repair facilities and their capabilities; v) allow for program management to ensure customers are provided availability for estimate and repairs; vi) allow for program admin to enforce vehicle prioritization agreements to give priority over other vehicles during the repair process; and vii) allowing for data driven decisions around shop capacity, such as, but not limited to, adding capacity, removing capacity, and assisting with weather, etc.

Furthermore, the embodiments described herein improve upon existing technologies, and improve the functionality of computers, by more accurately predicting or identifying which repair facilities have capacity. The present embodiments improve the speed, efficiency, and accuracy in which such calculations and processor analysis may be performed. Due to these improvements, the aspects address computer-related issues regarding efficiency over conventional techniques. Thus, the aspects also address computer related issues that are related to efficiency metrics and ease of use, for example.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and nonvolatile RAM (NVRAM) memory. The above memory types are example only, and are thus not limiting as to the types of memory usable for storage of a computer program.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein may be encoded as executable instructions embodied in a tangible, non-transitory, computer readable medium, including, without limitation, a storage device, and a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

Furthermore, as used herein, the term “real-time” refers to at least one of the time of occurrence of the associated events, the time of measurement and collection of predetermined data, the time for a computing device (e.g., a processor) to process the data, and the time of a system response to the events and the environment. In the embodiments described herein, these activities and events may be considered to occur substantially instantaneously.

As used herein, the term “database” may refer to either a body of data, a relational database management system (RDBMS), or to both, and may include a collection of data including hierarchical databases, relational databases, flat file databases, object-relational databases, object oriented databases, and/or another structured collection of records or data that is stored in a computer system. The above examples are not intended to limit in any way the definition and/or meaning of the term database. Examples of RDBMS's include, but are not limited to, Oracle® Database, MySQL, IBM® DB2, Microsoft® SQL Server, Sybase®, and PostgreSQL. However, any database may be used that enables the systems and methods described herein. (Oracle is a registered trademark of Oracle Corporation, Redwood Shores, Calif.; IBM is a registered trademark of International Business Machines Corporation, Armonk, N.Y.; Microsoft is a registered trademark of Microsoft Corporation, Redmond, Wash.; and Sybase is a registered trademark of Sybase, Dublin, Calif.)

In one embodiment, a computer program is provided, and the program is embodied on a computer readable medium. In an exemplary embodiment, the system is executed on a single computer system, without requiring a connection to a sever computer. In a further embodiment, the system is being run in a Windows® environment (Windows is a registered trademark of Microsoft Corporation, Redmond, Wash.). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, Calif.). In yet a further embodiment, the system is run on a Mac OS® environment (Mac OS is a registered trademark of Apple Inc. located in Cupertino, Calif.). In still yet a further embodiment, the system is run on Android® OS (Android is a registered trademark of Google, Inc. of Mountain View, Calif.). In another embodiment, the system is run on Linux® OS (Linux is a registered trademark of Linus Torvalds of Boston, Mass.). The application is flexible and designed to run in various different environments without compromising any major functionality.

In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. A computer system for monitoring a plurality of repair facilities, the computer system including at least one processor in communication with at least one memory device, the computer system in communication with a user computer device associated with a user, the at least one processor is programmed to:
store a plurality of historical vehicle repair information for a plurality of repair facilities;
collect a plurality of vehicle repair information from the plurality of repair facilities;
for each of the plurality of repair facilities, determine a current load for the corresponding repair facility;
receive, from a user computer device, a query for information about one or more repair facilities;
generate a user interface to include results of the query based on the plurality of historical vehicle repair information and the plurality of vehicle repair information; and
instruct the user computer device to display the user interface.

2. The computer system of claim 1, wherein the at least one processor is further programmed to store the plurality of vehicle repair information from the plurality of repair facilities.

3. The computer system of claim 1, wherein the at least one processor is further programmed to:
analyze the plurality of vehicle repair information;
calculate a plurality of metrics based on the analysis of the plurality of vehicle repair information; and
display one or more metrics of the plurality of metrics on the user interface.

4. The computer system of claim 1, wherein the at least one processor is further programmed to:
sort the plurality of vehicle repair information by geographic area; and
generate the user interface to provide vehicle repair information based on a user selected geographic area.

5. The computer system of claim 1, wherein the at least one processor is further programmed to:
automatically detect a discrepancy based on the plurality of vehicle repair information; and
present the discrepancy via the user interface.

6. The computer system of claim 1, wherein the at least one processor is further programmed to determine a current capacity of the plurality of repair facilities based on the plurality of vehicle repair information.

7. The computer system of claim 6, wherein the at least one processor is further programmed to:
receive a current or future weather condition; and
determine a needed capacity based on the current or future weather condition, the plurality of vehicle repair information, and the plurality of historical vehicle repair information.

8. The computer system of claim 6, wherein the at least one processor is further programmed to:
calculate a current capacity for a repair facility of the plurality of repair facilities based on the calculated capacity and information from a repair facility computer device; and
instruct the user interface to display the current capacity for the repair facility.

9. The computer system of claim 6, wherein the at least one processor is further programmed to:
calculate a current capacity for a market region including a plurality of repair facilities based on the plurality of calculated capacities and information from a plurality of repair facility computer devices; and
instruct the user interface to display the current capacity for the market region.

10. The computer system of claim 6, wherein the at least one processor is further programmed to:
calculate a current capacity for an entire enterprise including the plurality of repair facilities based on the plurality of calculated capacities and information from a plurality of repair facility computer devices; and
instruct the user interface to display the current capacity for the entire enterprise.

11. The computer system of claim 1, wherein the at least one processor is further programmed to:
provide filtering options on the user interface;
receive, from the user computer device, one or more selections of the filtering options via the user interface; and
update the user interface based on the one or more selections of the filtering options.

12. The computer system of claim 11, wherein the at least one processor is further programmed to retrieve information to display on the user interface based on the one or more selections of the filtering options.

13. A computer-implemented method for monitoring a plurality of repair facilities, the method implemented by a on a repair monitoring (“RM”) computer system comprising at least one processor in communication with at least one memory device, the RM computer system in communication with a user computer device associated with a user, the method comprises:
storing a plurality of historical vehicle repair information for a plurality of repair facilities;
collecting a plurality of vehicle repair information from the plurality of repair facilities;
for each of the plurality of repair facilities, determining a current load for the corresponding repair facility;
receiving, from a user computer device, a query for information about one or more repair facilities;
generating a user interface to include results of the query based on the plurality of historical vehicle repair information and the plurality of vehicle repair information; and
instructing the user computer device to display the user interface.

14. The method of claim 13 further comprising:
analyzing the plurality of vehicle repair information;
calculating a plurality of metrics based on the analysis of the plurality of vehicle repair information; and
displaying one or more metrics of the plurality of metrics on the user interface.

15. The method of claim 13 further comprising:
sorting the plurality of vehicle repair information by geographic area; and
generating the user interface to provide vehicle repair information based on a user selected geographic area.

16. The method of claim 13 further comprising:
automatically detecting a discrepancy based on the plurality of vehicle repair information; and
presenting the discrepancy via the user interface.

17. The method of claim 13 further comprising determining a current capacity of the plurality of repair facilities based on the plurality of vehicle repair information.

18. The method of claim 17 further comprising:
receiving a current or future weather condition; and
determining a needed capacity based on the current or future weather condition, the plurality of vehicle repair information, and the plurality of historical vehicle repair information.

19. The method of claim 17 further comprising:
calculating a current capacity for a repair facility of the plurality of repair facilities based on the calculated capacity and information from a repair facility computer device; and
instructing the user interface to display the current capacity for the repair facility.

20. The method of claim 17 further comprising:
calculating a current capacity for a market region including a plurality of repair facilities based on the plurality of calculated capacities and information from a plurality of repair facility computer devices; and
instructing the user interface to display the current capacity for the market region.

21. The method of claim 17 further comprising:
calculating a current capacity for an entire enterprise including the plurality of repair facilities based on the plurality of calculated capacities and information from a plurality of repair facility computer devices; and
instructing the user interface to display the current capacity for the entire enterprise.

22. The method of claim 14 further comprising:
providing filtering options on the user interface;
receiving, from the user computer device, one or more selections of the filtering options via the user interface; and
update the user interface based on the one or more selections of the filtering options.

23. The method of claim 22 further comprising retrieving information to display on the user interface based on the one or more selections of the filtering options.
